(19) United States
(12) Patent Application Publication
(10) Pub. No.: US 2013/0208177 A1
(43) Pub. Date: Aug. 15, 2013

(54) ELECTRONIC APPARATUS HAVING OPERATION PORTION

(71) Applicant: SANYO Electric Co., Ltd., (US)

(72) Inventor: Daizo Kobayashi, Hirakata-shi (JP)

(73) Assignee: SANYO ELECTRIC CO., LTD., Osaka (JP)

(21) Appl. No.: 13/763,229

(22) Filed: Feb. 8, 2013

(30) Foreign Application Priority Data
Feb. 10, 2012 (JP) 2012-026837

(51) Int. Cl. H04N 5/232

(52) U.S. Cl. CPC H04N 5/23296
USPC 348/347

(57) ABSTRACT

In an electronic apparatus of the present invention, a torsion spring includes a coil portion and paired arm portions. An operation member is provided with paired engagement target portions with which the tip portions of the paired arm portions of the torsion spring engage. A housing is provided with paired receiving portions on both sides of the tip portions of the paired arm portions of the torsion spring. The operation member is provided with a seat portion where the coil portion of the torsion spring is to be installed. In connection with the seat portion, the installation face of the coil portion has a height difference, so as to allow the coil portion to be inclined in the direction uniformizing the engagement amount of the paired arm portions with respect to the paired engagement target portions.

### CROSS-REFERENCE TO RELATED APPLICATIONS

The present application claims priority to Japanese Patent Application No. 2012-026837. The entirety of Japanese Patent Application No. 2012-026837 is incorporated by reference herein.

### BACKGROUND OF THE INVENTION

1. Field of the Invention

The present invention relates to an electronic apparatus such as a digital camera, a video camera and the like.

2. Description of Related Art

A digital camera or a video camera includes an operation portion for performing a zoom operation at its housing. The operation portion is connected to a zoom variable apparatus in the housing via a zoom operation mechanism.

The zoom operation mechanism includes: an operation member being protrusively provided with the operation portion, the operation member being capable of rotating relative to the housing; and a torsion spring rotationally biasing the operation member relative to the housing. The torsion spring has a coil portion pivotally supported at the housing by a screw. By paired arm portions protrusively provided to the coil portion, an elastic repulsive force is provided to the bidirectional rotary movement of the operation member.

Accordingly, when the operation portion is operated in any one direction against the elasticity of the torsion spring, the zoom variable apparatus operates in accordance with the rotation of the operation member.

With the zoom operation mechanism described above, the torsion spring is attached to the housing by the screw.

On the other hand, in addition to the zoom operation mechanism in which the torsion spring is pivotally supported by the screw, the zoom operation mechanism shown in FIGS. 10 to 12 is employed.

The zoom operation mechanism includes: a circular attaching portion 91 formed at a cover cabinet 9 structuring a housing; a zoom operation knob 96 rotatably arranged on the front surface side of the attaching portion 91; a spring holding piece 99 rotatably arranged on the back surface side of the attaching portion 91; and a torsion spring 98 interposed between the attaching portion 91 and the spring holding piece 99. The zoom operation knob 96 and the spring holding piece 99 are coupled to each other by screws 100, 100, to integrally rotate bidirectionally.

The torsion spring 98 is structured having paired arm portions protrusively provided at the both ends of the coil portion.

The zoom operation knob 96 is protrusively provided with an operation portion 97. Further, on the front surface of the zoom operation knob 96, a shutter button 94 is installed at the center portion thereof via the coil spring 95.

In the assembly process before the spring holding piece 99 is coupled to the zoom operation knob 96, the torsion spring 98 is tentatively attached to the attaching portion 91 of the cover cabinet 9 in the state where the arm portions are pressed against paired pins 92, 92 of the cover cabinet 9 by elastic repulsive force as shown in FIG. 11.

In this state, on the both sides of the torsion spring 98 having the tip portions of the paired arm portions interposed therebetween, paired pressing walls 99a, 99a formed at the spring holding piece 99 are arranged so as to oppose to each other, as shown in FIG. 12.

Accordingly, when the operation portion 97 of the zoom operation knob 96 shown in FIG. 10 is rotated in any one direction, the zoom operation knob 96 and the spring holding piece 99 integrally rotate. The rotation of the spring holding piece 99 causes one of the pressing walls 99a of the spring holding piece 99 to press one of the tip portions of the torsion spring 98, whereby the torsion spring 98 is elastically deformed.

In conjunction with the rotation of the spring holding piece 99, the zoom variable apparatus (not shown) operates.

Thereafter, when the zoom operation knob 96 is released from the user's hand, the zoom operation knob 96 returns to the original neutral position by the biasing force of the torsion spring 98.

In the assembly process of the zoom operation mechanism shown in FIGS. 10 to 12, the torsion spring 98 is tentatively attached to the cover cabinet 9 as shown in FIG. 11 and thereafter the spring holding piece 99 is fixed by screws to the zoom operation knob 96 as shown in FIG. 10.

However, with the zoom operation mechanism shown in FIGS. 10 to 12, the both tip portions of the paired arm portions of the torsion spring 98 are merely hooked by the pressing walls 99a, 99a of the spring holding piece 99. Furthermore, while the one arm portion of the torsion spring 98 projects from the top end of the coil portion, the other arm portion projects from the bottom end of the coil portion. Accordingly, the arm portions differ from each other in height, and hence the arm portions differ from each other in the hooked amount relative to the spring holding piece 99. This causes the one arm portion with the smaller hooked amount prone to come off from the spring holding piece 99, disadvantageously hindering the operation of the zoom operation mechanism.

Accordingly, an object of the present invention is to provide an electronic apparatus having an operation mechanism exhibiting an elastic repulsive force by a torsion spring in response to an operation of an operation portion, in which operation reliability of the operation mechanism is improved as compared to conventional apparatuses.

### SUMMARY OF THE INVENTION

An electronic apparatus of the present invention includes an operation member that has an operation portion and that is attached to a housing so as to be capable of rotating when operated, and a torsion spring providing an elastic repulsive force in response to an operation of the operation portion about a rotation axis of the operation member.

The torsion spring includes a coil portion and paired arm portions outwardly projecting from both ends of the coil portion.

The operation member includes paired engagement target portions with which tip portions of the paired arm portions of the torsion spring are to engage.

The housing is provided with paired receiving portions for receiving the paired arm portions on both sides of the tip portions of the paired arm portions of the torsion spring.

The operation member is provided with a seat portion to which the coil portion of the torsion spring is to be set. In connection with the seat portion, an installation face for the coil portion has a height difference for allowing the coil portion to be inclined in a direction uniformizing an engagement amount (engagement amount) of the paired arm portions projecting from the both ends of the coil portion with respect to the paired engagement target portions.

### BRIEF DESCRIPTION OF THE DRAWINGS

FIG. 1 is a perspective view of a digital camera, which is one embodiment of the present invention;

FIG. 2 is a diagram of a zoom operation mechanism of the digital camera in the neutral state, as seen from the back surface side of a cover cabinet;

FIG. 3 is a diagram of the zoom operation mechanism of the digital camera as being operated in one direction, as seen from the back surface side of the cover cabinet;

FIG. 4 is a diagram showing the state where a spring holding piece is removed from the zoom operation mechanism shown in FIG. 2;

FIG. 5 is an exploded perspective view showing the zoom operation mechanism of the digital camera;

FIG. 6 is an enlarged perspective view showing the spring holding piece to which a torsion spring is attached;

FIG. 7 is an enlarged perspective view showing the state where the torsion spring is removed from the spring holding piece;

FIG. 8 is an enlarged perspective view as seen from the direction being different from that in FIG. 6;

FIG. 9 is an enlarged perspective view as seen from the direction being different from that in FIG. 7;

FIG. 10 is a perspective view showing a zoom operation mechanism in a conventional digital camera;

FIG. 11 is a rear view of the zoom operation mechanism in the conventional digital camera;

FIG. 12 is an exploded perspective view of the zoom operation mechanism in the conventional digital camera;

FIG. 13 is a perspective view of an improved operation member according to other embodiment of the present invention;

FIG. 14 is a side view of the operation member according to the other embodiment of the present invention;

FIG. 15 is a cross-sectional view of the operation member according to the other embodiment of the present invention; and

FIG. 16 is a perspective view of a spring holding piece structuring the operation member according to the other embodiment of the present invention.

### DETAILED DESCRIPTION OF THE PREFERRED EMBODIMENT

In the following, with reference to the drawings, a description will specifically be given of the modes in which the present invention is applied to a digital camera.

As shown in FIG. 1, the digital camera being one embodiment of the present invention includes an image capturing lens 11 at the front face portion of a housing 1, a shutter button 3, and an operation member 4 having an operation portion 51. The shutter button 3 and the operation member 4 are arranged at a cover cabinet 2 forming the top face wall of the housing 1.

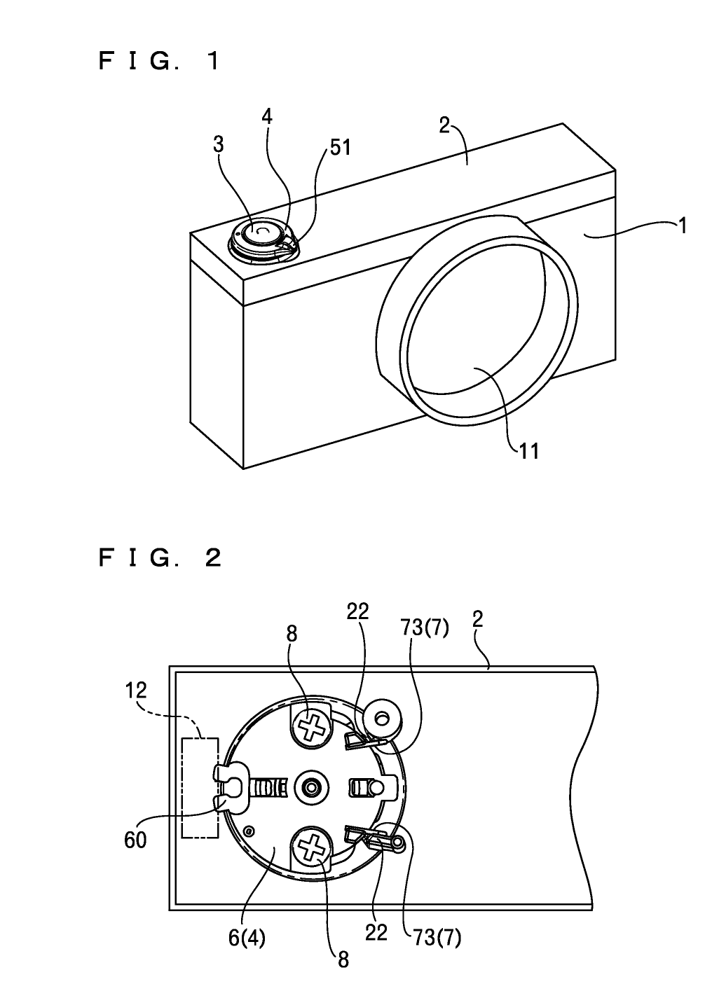

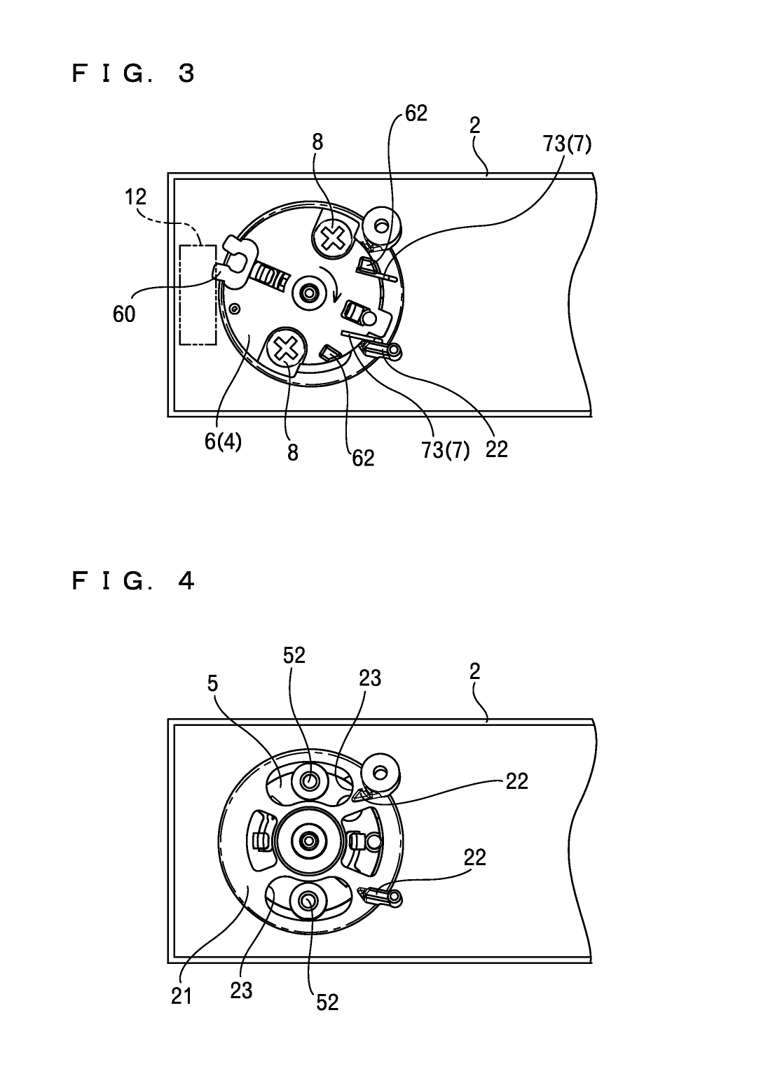

When the operation portion 51 is operated to rotate in any one direction, the operation member 4 rotates from the neutral position shown in FIG. 2 to the one rotation end as shown in FIG. 3, for example. Thus, a zoom variable apparatus 12 as a function unit to which a coupling portion 60 formed at the operation member 4 is connected operates.

It is to be noted that the zoom variable apparatus 12 specifically includes mechanical structures such as known optical mechanisms or electric structures such as switches.

Firstly, a description will be given of the basic structure of a zoom operation mechanism in the digital camera according to one embodiment of the present invention. Thereafter, a description will be given of the structure of a zoom operation mechanism with improved operation reliability according to another embodiment of the present invention.

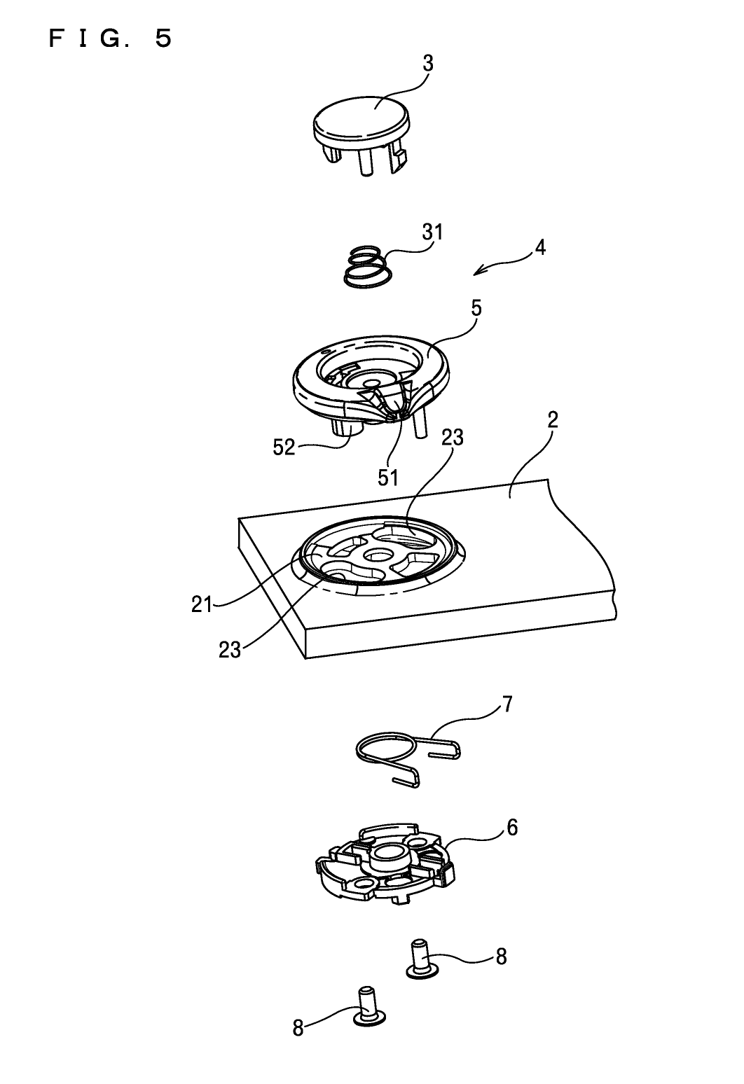

As shown in FIG. 5, the operation member 4 includes a disc-like zoom operation knob 5 arranged on the front surface side of the circular attaching portion 21 formed at the cover cabinet 2, a disc-like spring holding piece 6 arranged on the back surface side of the attaching portion 21, a torsion spring 7 interposed between the cover cabinet 2 and the spring holding piece 6, and two screws 8, 8 fixing the spring holding piece 6 to the zoom operation knob 5.

The operation portion 51 is protrusively provided at the zoom operation knob 5. Further, the center portion of the zoom operation knob 5 is arranged with a shutter button 3 via a coil spring 31.

Paired arc-shaped holes 23, 23 through which the screws 8, 8 are to penetrate are provided at the attaching portion 21 of the cover cabinet 2.

Further, as shown in FIG. 4, paired bosses 52, 52 with which the screws 8, 8 are to be screwed are protrusively provided on the back surface of the zoom operation knob 5.

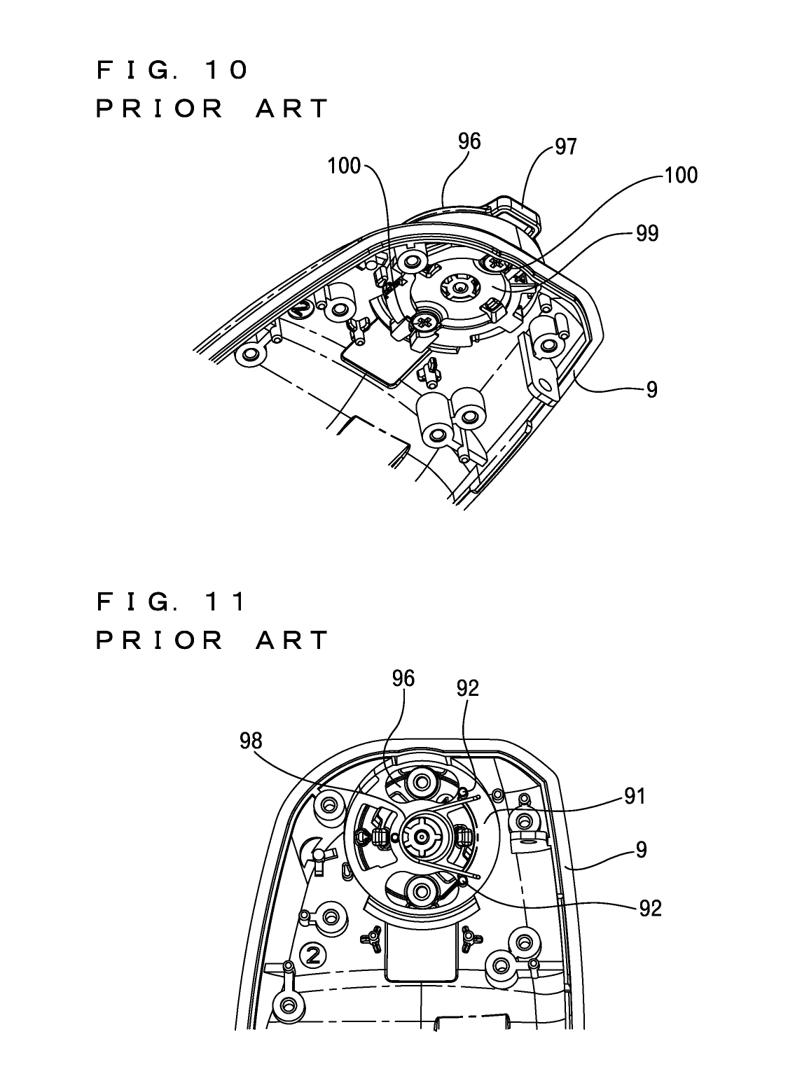

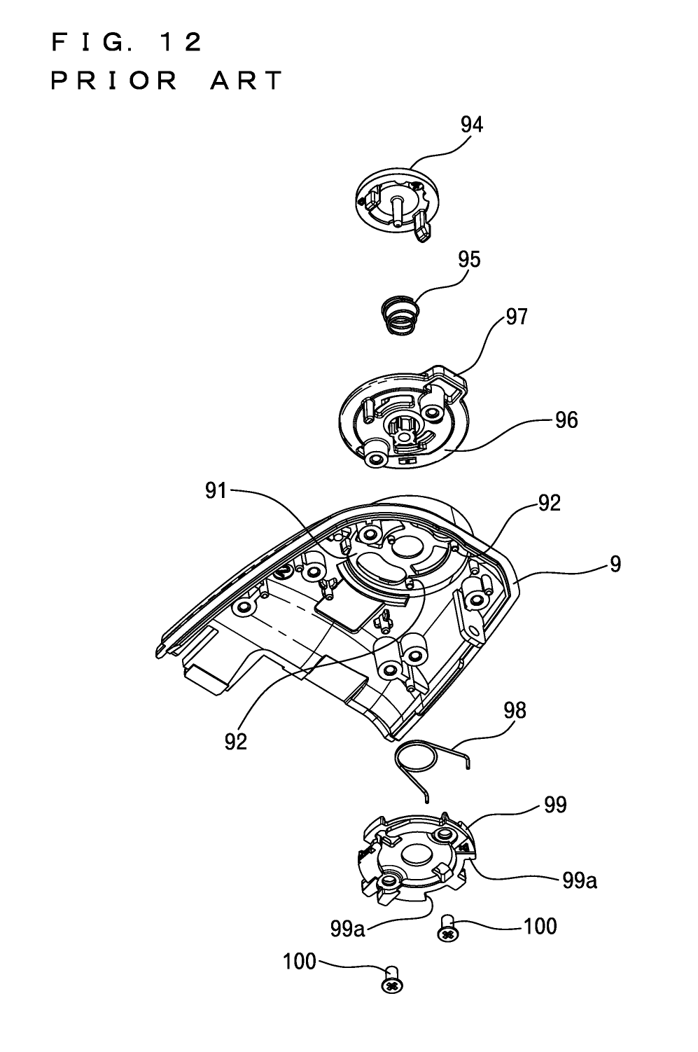

As shown in FIGS. 7 and 9, the torsion spring 7 includes a coil portion 71 and paired arm portions 72, 72 outwardly projecting from the coil portion 71 and having elasticity in the enlarging and reducing directions. U-shaped portions 73, 73 bending in a U-shaped manner are formed at the tip portions of the arm portions 72, 72.

The spring holding piece 6 is provided with a boss 64 at the center portion of the circular plate portion 61, and paired projection pieces 62, 62 on the rear surface of the circular plate portion 61. Paired through holes 63, 63 through which the screws 8, 8 are to penetrate are provided on both the sides of the boss 64. Further, a nail piece 65 is protrusively provided on the outer circumferential face of the boss 64. Still further, the coupling portion 60 is formed at the outer circumferential portion of the circular plate portion 61.

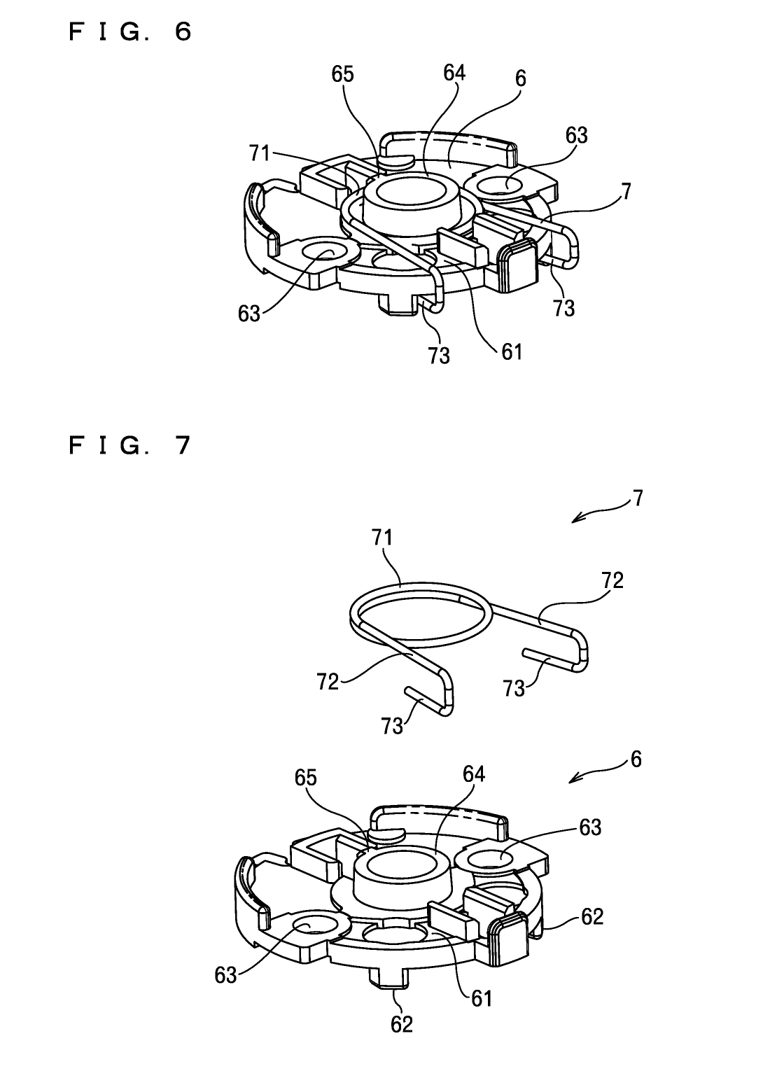

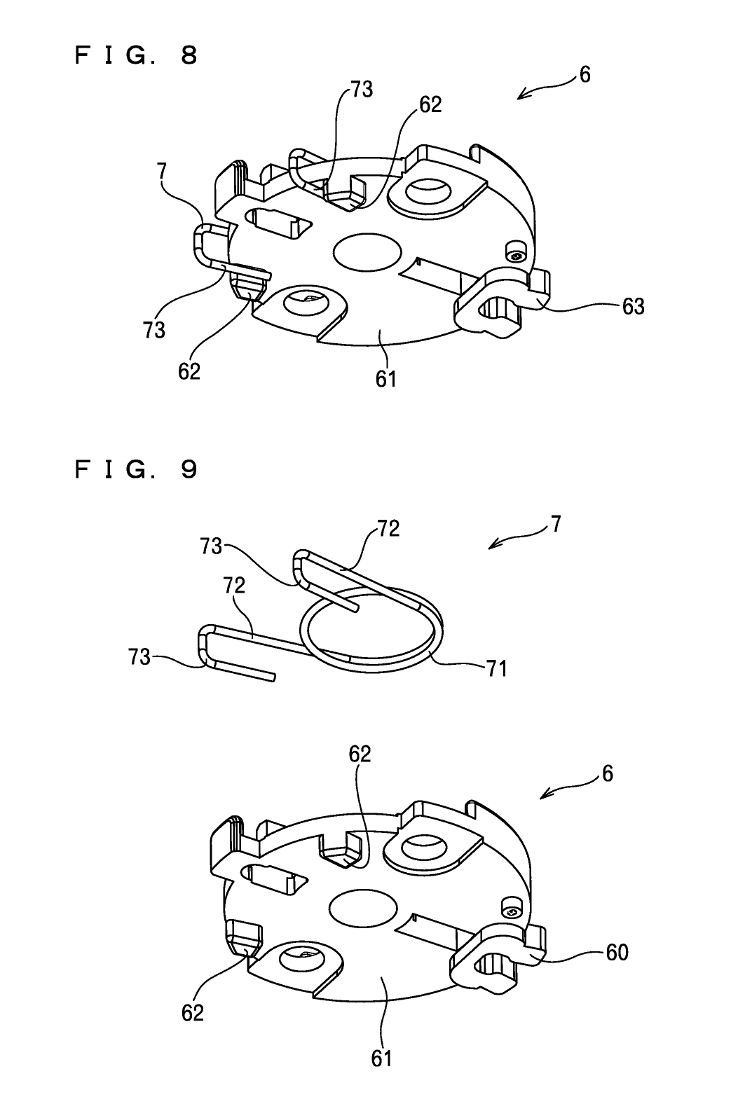

As shown in FIGS. 6 and 8, in connection with the torsion spring 7, the coil portion 71 is arranged to surround the boss 64 of the spring holding piece 6, and the coil portion 71 is engagingly stopped by the nail piece 65 of the boss 64.

Further, in connection with the torsion spring 7, the paired arm portions 72, 72 extend toward the outer circumferential portion of the spring holding piece 6, and the U-shaped portions 73, 73 clamp the outer circumferential edge portion of the circular plate portion 61 of the spring holding piece 6 from the both sides, and are engagingly stopped by the spring holding piece 6.

Thus, the torsion spring 7 is prevented from coming off from the spring holding piece 6.

Then, the tips of the paired U-shaped portions 73, 73 of the torsion spring 7 are respectively pressed against the inner side faces of the paired projection pieces 62 and 62 of the spring holding piece 6, and the elastic repulsive force in the opening direction of the paired arm portions 72, 72 of the torsion spring 7 is received (see FIG. 2).

In this state, the paired U-shaped portions 73, 73 of the torsion spring 7 project outward from the outer circumferential face of the spring holding piece 6.

In the state where the zoom operation mechanism described above is installed in the cover cabinet 2, as shown in FIG. 2, on the both sides of the paired U-shaped portions 73, 73 of the torsion spring 7, the paired receiving pieces 22, 22 of the cover cabinet 2 oppose to each other.

Accordingly, when the operation portion 51 of the operation member 4 is operated to rotate in any one direction, the operation member 4 rotates from the neutral position shown in FIG. 2 in one direction as indicated by the arrow as shown in FIG. 3, for example. In accordance therewith, any one projection piece 62 presses one of the U-shaped portions 73 of the torsion spring 7. This causes the torsion spring 7 to be elastically deformed in the state where the other U-shaped portion 73 is received by one of the receiving pieces 22 of the cover cabinet 2 in the direction where the paired arm portions 72 and 72 close.

In conjunction with the displacement of the coupling portion 60 of the spring holding piece 6 in accordance with the rotation of the operation member 4, the zoom variable apparatus (not shown) operates.

Thereafter, when the operation portion 51 is released from the user's hand, the operation member 4 returns to the neutral position shown in FIG. 2 by the elastic repulsive force of the torsion spring 7.

In the assembly process of the zoom operation mechanism described above, as shown in FIGS. 6 and 8, the torsion spring 7 is engagingly stopped at the spring holding piece 6. Thereafter, the zoom operation knob 5 and the spring holding piece 6 are arranged on the both sides of the attaching portion 21 of the cover cabinet 2 shown in FIG. 5, and the spring holding piece 6 is fixed to the zoom operation knob 5 by the screws 8, 8 (see FIG. 3).

Here, as described above, since the torsion spring 7 is prevented from coming off from the spring holding piece 6, the torsion spring 7 will not easily come off from the spring holding piece 6 when the spring holding piece 6 is fixed to the zoom operation knob 5. Accordingly, the assembly work of the zoom operation mechanism is facilitated.

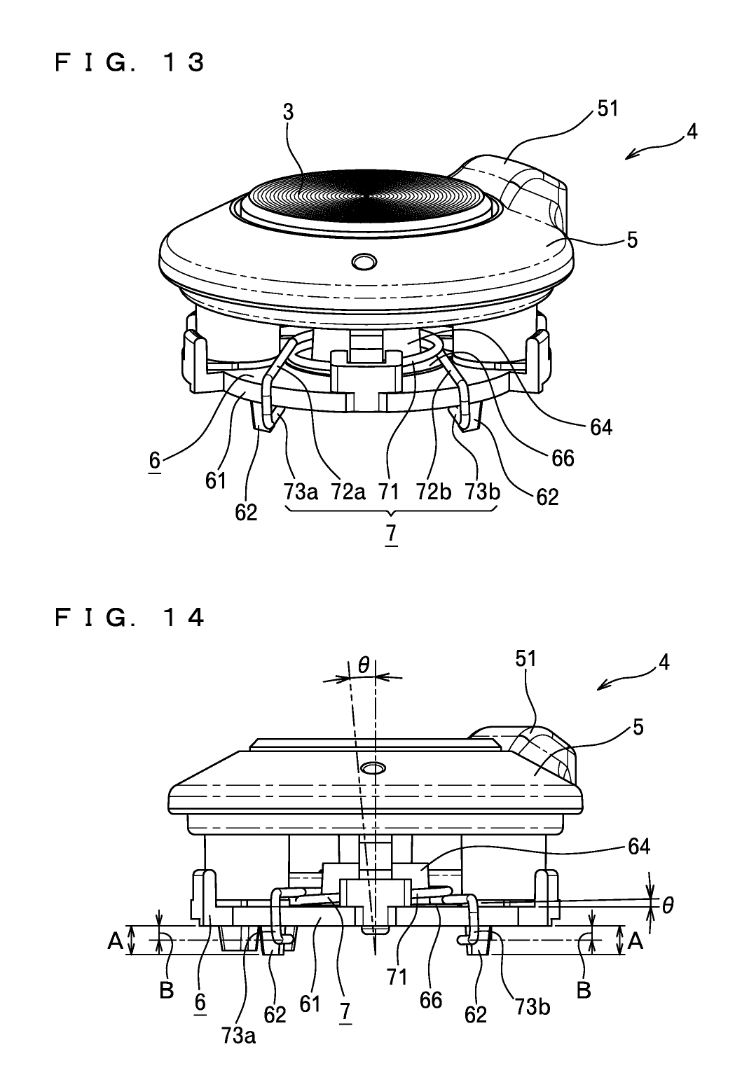

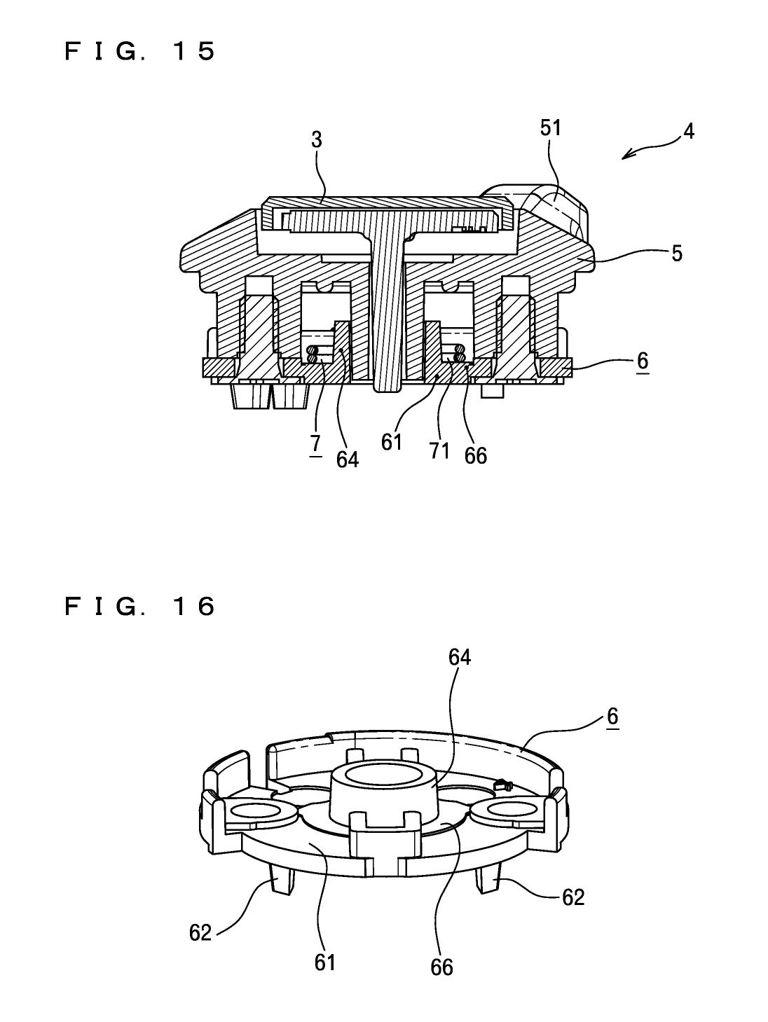

FIGS. 13 to 16 show the structure of the operation member 4, which is modified to improve the operation reliability of the zoom operation mechanism. It is to be noted that identical reference characters are allotted to the structures having identical function as the structures of the zoom operation mechanism shown in FIGS. 1 to 9, and the description thereof will not be repeated.

The operation member 4 is structured by coupling the zoom operation knob 5 and the spring holding piece 6 to each other. The torsion spring 7 is attached to the spring holding piece 6.

The spring holding piece 6 is protrusively provided with the boss 64 at the center portion of the circular plate portion 61. Surrounding the boss 64, a seat portion 66 where the coil portion 71 of the torsion spring 7 is to be installed is formed.

The torsion spring 7 is installed on the seat portion 66 of the spring holding piece 6, in the state where the coil portion 71 is loosely fitted to the outer circumferential face of the boss 64 of the spring holding piece 6.

Here, the seat portion 66 of the spring holding piece 6 has its front surface, i.e., the installation face for the coil portion 71 of the torsion spring 7, formed as an inclined plane. In order to allow the coil portion 71 to be inclined in the direction causing the one arm portion 72b, which is one of paired arm portions 72a, 72b projecting from the both ends of the coil portion 71 of the torsion spring 7 and which is nearer to the circular plate portion 61 of the spring holding piece 6, to be away from the circular plate portion 61 of the operation member 4, the inclined plane is inclined so as to be higher toward the arm portion 72b.

Accordingly, as shown in FIG. 14, when the inclination angle of the seat portion 66 of the spring holding piece 6 is θ, the coil portion 71 of the torsion spring 7 is inclined by angle θ with reference to the rotation axis of the operation member 4.

As a result, the one arm portion 72b out of the paired arm portions 72a and 72b nearer to the circular plate portion 61 of the spring holding piece 6 becomes away from the circular plate portion 61 of the operation member 4, and the engagement amount (hooked amount) B of the U-shaped portion 73b of the arm portion 72b with respect to the projection piece 62 and the engagement amount (hooked amount) B of the other arm portion 72a with respect to the projection piece 62 become substantially identical to each other.

Hence, a height A of the paired projection pieces 62, 62 which should protrusively be provided to the circular plate portion 61 of the spring holding piece 6 is identical to both the arm portions 72a and 72b. Further, the height A can be set to the minimum required size for the U-shaped portions 73a and 73b to engage by the full engagement amount B. Thus, as will be described in the following, the digital camera can be reduced in size.

With the digital camera having the zoom operation mechanism described above, when the operation member 4 is at the neutral position, the receiving pieces 22, 22 of the cover cabinet 2 face the U-shaped portions 73a and 73b of the torsion spring 7 with a slight interval therebetween, in the state where the U-shaped portions 73a and 73b of the torsion spring 7 are pressed against the inner side faces of the projection pieces 62, 62 of the spring holding piece 6.

When the operation portion 51 is operated from this state to rotate the zoom operation knob 5 and the spring holding piece 6 in one direction, one projection piece 62 of the spring holding piece 6 presses one U-shaped portion 73 of the torsion spring 7. Thus, the torsion spring 7 is elastically deformed in the state where the other U-shaped portion 73 is received by the receiving piece 22 of the cover cabinet 2. Thus, elastic repulsive force acts in response to the operation of the operation portion 51.

With the digital camera having the zoom operation mechanism described above, since the height of the paired projection pieces 62, 62 projecting downwardly from the operation member 4 can be set to the minimum required dimension, a reduction in size of the digital camera can be achieved by setting the clearance between any structure to be arranged below the operation member 4 (e.g., the circuit board, the flexible printed circuit board and the like) to be small.

Here, since the hooked amount of the arm portions 72a and 72b of the torsion spring 7 with the projection pieces 62, 62 is fully secured, disengagement of the one arm portion 72b from the projection piece 62 will not occur and, therefore, the function of the torsion spring 7 will not be impaired.

Incidentally, the configuration of each of the constituent parts according to the present invention is not limited to that in the above-described preferred embodiment. Various changes can be made by those skilled in the art within the range not departing from the spirit of the present invention.

Further, the present invention can be applied to various electronic apparatuses having an operation portion, without being limited to a digital camera. In this case, the operation mechanism can be connected to various function units structuring the apparatus, without being limited to the zoom variable apparatus.

What is claimed is:

1. An electronic apparatus having an operation portion, comprising:
an operation member that has the operation portion and that is attached to a housing so as to be capable of rotating when operated; and
a torsion spring which provides an elastic repulsive force in response to an operation of the operation member, wherein
the torsion spring includes a coil portion and paired arm portions which outwardly project from both ends of the coil portion,
the operation member includes paired engagement target portions with which tip portions of the paired arm portions of the torsion spring are to engage,
the housing is provided with paired receiving portions which receives the paired arm portions on both sides of the tip portions of the paired arm portions of the torsion spring,
the operation member is provided with a seat portion to which the coil portion of the torsion spring is to be installed, and
in connection with the seat portion, an installation face for the coil portion has a height difference which allows the coil portion to be inclined in a direction uniformizing an engagement amount of the paired arm portions with respect to the paired engagement target portions.

2. An electronic apparatus having an operation portion, comprising:
an operation member that has the operation portion and that is attached to a housing so as to be capable of rotating when operated; and
a torsion spring which provides an elastic repulsive force in response to an operation of the operation portion about a rotation axis of the operation member, wherein
the torsion spring includes a coil portion and paired arm portions which outwardly project from both ends of the coil portion, tip portions of the paired arm portions which is respectively provided with U-shaped portions bending in a U-shaped manner,
the operation member includes a circular plate portion capable of rotating about the rotation axis, a boss protrusively provided at a center portion of one surface of the circular plate portion, and paired projection pieces protrusively provided at an outer circumferential portion of other surface of the circular plate portion so as to be away from each other,
in connection with the torsion spring, the coil portion fits to an outer circumferential face of the boss of the operation member, and the U-shaped portions clamp an outer circumferential edge portion of the circular plate portion of the operation member from both faces to engage with the outer circumferential edge portion, tips of the U-shaped portions facing inner side faces of the paired projection pieces,
the housing is provided with paired receiving pieces which receives the U-shaped portions on both sides of the U-shaped portions of the torsion spring,
the operation member is provided around the boss with a seat portion to which the coil portion of the torsion spring is to be installed,
in connection with the seat portion, an installation face for the coil portion has a height difference which allows the coil portion to be inclined in a direction causing one arm portion to become away from the circular plate portion of the operation member, the one arm portion projecting from a bottom edge nearer to the circular plate portion of the operation member out of both ends of the coil portion.

3. The electronic apparatus according to claim 1, wherein
the installation face for the seat portion is formed as an inclined plane.

4. The electronic apparatus according to claim 2, wherein
the installation face for the seat portion is formed as an inclined plane.

5. The electronic apparatus according to claim 1, wherein
the operation member is structured by an operation knob which has the operation portion and a spring holding piece connected to a function unit in the housing, which are coupled to each other so as to be integrally rotatable, the torsion spring which is attached to the spring holding piece.

6. The electronic apparatus according to claim 2, wherein
the operation member is structured by an operation knob which has the operation portion and a spring holding piece connected to a function unit in the housing, which are coupled to each other so as to be integrally rotatable, the torsion spring which is attached to the spring holding piece.

7. The electronic apparatus according to claim 3, wherein
the operation member is structured by an operation knob which has the operation portion and a spring holding piece connected to a function unit in the housing, which are coupled to each other so as to be integrally rotatable, the torsion spring which is attached to the spring holding piece.

8. The electronic apparatus according to claim 4, wherein
the operation member is structured by an operation knob which has the operation portion and a spring holding piece connected to a function unit in the housing, which are coupled to each other so as to be integrally rotatable, the torsion spring being attached to the spring holding piece.
